(19) United States
(12) Patent Application Publication
(10) Pub. No.: US 2008/0079738 A1
(43) Pub. Date: Apr. 3, 2008

(54) METHOD AND SYSTEM FOR TESTING COMPUTER GRAPHIC DISPLAY CONTROLLER

(75) Inventor: Chien Lin Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/537,132

(22) Filed: Sep. 29, 2006

(51) Int. Cl. G06F 13/14

(52) U.S. Cl. 345/520

(57) ABSTRACT

The invention provides a system and method of testing a computer graphic display controller applicable to a computer platform, for allowing the user to perform testing procedures on a graphic display controller installed in a computer, characterized in that all video formats that need to be set for testing the graphic display controller can be automatically retrieved and displayed on the user's operating interface, thereby enabling the user to conveniently and quickly be informed of all video formats that are supported by the computer of an indicated graphic display controller under test, and also the efficiency of testing can be improved by reducing the number of times that the user has to click the mouse buttons.

### BACKGROUND OF THE INVENTION

1. Field of the Invention

This invention relates to information technology (IT), and more particularly, to a computer graphic display controller testing method and system for testing a graphic display controller installed on a computer platform.

2. Description of Related Art

In the use of computers, the monitor screen is controlled by a graphic display controller, such as a VGA (Video Graphic Array) chipset or expansion card. Therefore, computer products are typically pre-installed in factory with a graphic display controller, and it is an important task for the computer manufacturer to test the operability of the pre-installed graphic display controller before shipment to the customer.

In the testing of a graphic display controller, the QC (Quality Control) engineers need first to set the graphic display controller to operate under various video format settings (each video format setting is a combination of resolution, color depth, and scan frequency), and then carry out a series of test procedures on the graphic display controller. These test procedures include, for example, (T1) a multimedia file play test procedure; (T2) a window resizing test procedure; (T3) a window and icon dragging test procedure; and (T4) a text-based user interface test procedure.

Microsoft's Windows operating systems are presently the most widely utilized operating systems on computer platforms, including network servers, desktop computers, and notebook computers. To test a graphic display controller under a Microsoft Windows operating system, the QC engineers need to manually set the graphic display controller to various video format settings, which includes the following steps:

(S1) choose a resolution setting: which includes the substeps of clicking the right mouse button anywhere on the desktop (a fly-open menu appears), choosing [Properties] from the menu (a dialog box appears), choosing [Settings] from the dialog box to switch to a settings page, and then choosing a resolution setting from the settings page;

(S2) choose a scan frequency: which includes the substeps of clicking the [Advanced] button from the Settings page of the dialog box opened in step (S1) to switch to a General page, choosing a screen DPI setting from the General page, and then choose [OK] and [Apply];

(S3) carry out a multimedia file play test procedure: which includes the substeps of manually opening a multimedia file, such as an AVI video file, playing it, and visually inspecting whether the video file can play smoothly on the screen;

(S4) carry out a window resizing test procedure: which includes the substeps of manually opening a window, and then manually resizing the window to see if the window can be resized normally;

(S5) carry out a window and icon dragging test procedure: which includes the substeps of manually dragging an open window or an icon on the desktop, and then visually inspecting if there are residual traces left behind the dragged windows or icons during the course of the dragging; and

(S6) carry out a text-based user interface test procedure: which includes the substeps of manually switching the screen display to a traditional DOS (Disk Operating System) based user interface, displaying it in full-screen size under normal mode, and then manually inputting text to the screen and visually checking whether the DOS-based user interface and the inputted text can be correctly displayed.

During the testing operation, all the test procedures (T1)-(T4) should be carried out under different video format settings. For instance, the available video format settings on a typical personal computer many include [1024*768, 32-bit, 75 Hz], [800*600, 32-bit, 75 Hz], [1024*768, 16-bit, 60 Hz], and [800*600, 16-bit, 60 Hz]. In this case, the QC engineer needs first to manually set the graphic display controller to [1024*768, 32-bit, 75 Hz] and then carry out the test procedures (T1)-(T4); after this, manually set the graphic display controller to [800*600, 32-bit, 75 Hz] and then carry out the test procedures (T1)-(T4); and so forth, until each of all the video format settings has been set once for the test procedures (T1)-(T4). In some applications, the number of available video format settings may be more than 10.

One apparent drawback to the foregoing practice is that it requires the QC engineer to click the mouse too many times. For example, under the Microsoft Window operating system, the QC engineer need to click the right mouse button once and the left mouse button 11 times to complete the test procedures (T1)-(T4). This practice is undoubtedly quite tedious, laborious, and time-consuming for the QC engineer to implement, and is thus quite inefficient.

Moreover, during the testing operation, the QC engineers must read technical manuals about the graphic display controller and the computer platform in order to learn all the supported video format settings, so as to be assured that everyone of the available video format settings is used for the testing. This practice undoubtedly makes the testing operation more complicated for the QC engineers and is also laborious and time-consuming for the QC engineers to implement and is thus quite inefficient.

### SUMMARY OF THE INVENTION

It is therefore an objective of this invention to provide a computer graphic display controller testing method and system which allows the QC engineer to carry out the testing by using less number of mouse clicks to make the testing less laborious and time-consuming and more efficient to implement.

It is another objective of this invention to provide a computer graphic display controller testing method and system which allows the QC engineer to learn all the video formats supported by the computer platform where the graphic display controller under test is installed.

The computer graphic display controller testing method and system according to the invention is implemented through a software program for installation to the computer platform where the graphic display controller under test is installed.

In abstraction, the computer display controller testing method according to the invention comprises: (S1) responding to a user-initiated activation event by issuing an activation-enable message; (S2) responding to the activation-enable message by searching through the computer platform for all types of video formats that are supported by the computer platform; (S3) displaying a listing of all the possible combinations of video format settings from the supported video format types on the computer platform for user selection; (S4) setting the graphic display controller to operate under the user-selected video format setting; and (S5) performing a series of test procedures on the graphic display controller under the user-selected video format setting.

In concrete architecture, the computer display controller testing system according to the invention is designed to implement the aforementioned method, and which is based on an object-oriented component model comprising: (A) an activating module, which is capable of responding to a user-initiated activation event by issuing an activation-enable message; (B) a supported-format searching module, which is capable of responding to the activation-enable message from the activating module by searching through the computer platform for all types of video formats that are supported by the computer platform; (C) a user interface module, which is capable of displaying a listing of all the possible combinations of video format settings from the supported video format types found by the supported-format searching module on the computer platform; and which is capable of allowing a user-operated selection of one of the video format settings from the listing; (D) a video format setting module, which is capable of setting the graphic display controller to operate under the user-selected video format setting from the user interface module; and (E) a testing module, which is capable of performing a series of test procedures on the graphic display controller under the user-selected video format setting.

The computer graphic display controller testing method and system according to the invention is characterized in that all video formats that need to be set for testing the graphic display controller can be automatically retrieved and displayed on the user's operating interface, thereby enabling the user to conveniently and quickly be informed of all video formats that are supported by the computer of an indicated graphic display controller under test, and also the efficiency of testing can be improved by reducing the number of times that the user has to click the mouse buttons.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer graphic display controller testing system of the invention with a computer platform;

FIG. 2 is a schematic diagram showing an object-oriented component model of the computer graphic display controller testing system of the invention; and

FIG. 3 is a schematic diagram showing a dialog box displayed by a user interface module utilized by the computer graphic display controller testing system of the invention.

### DETAILED DESCRIPTION OF PREFERRED EMBODIMENTS

The computer graphic display controller testing method and system according to the invention is disclosed in full details by way of preferred embodiments in the following with reference to the accompanying drawings.

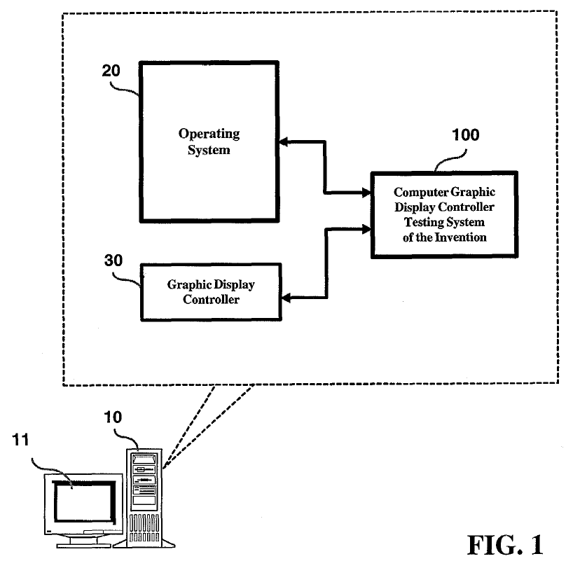

FIG. 1 is a schematic diagram showing the application of the computer graphic display controller testing system according to the invention (which is here encapsulated in a box indicated by the reference numeral 100). As shown, the computer graphic display controller testing system of the invention 100 is designed for use in conjunction with a computer platform 10, such as a network server, a desktop computer, or a notebook computer, that is equipped with a GUI (Graphic User Interface) based operating system 20, such as a Microsoft Windows NT/2000/XP operating system, and a graphic display controller 30, such as a VGA (Video Graphic Array) chipset or expansion card. Functionally, the computer graphic display controller testing system of the invention 100 is capable of performing a user-initiated testing operation on the graphic display controller 30 for test the operability of the graphic display controller 30.

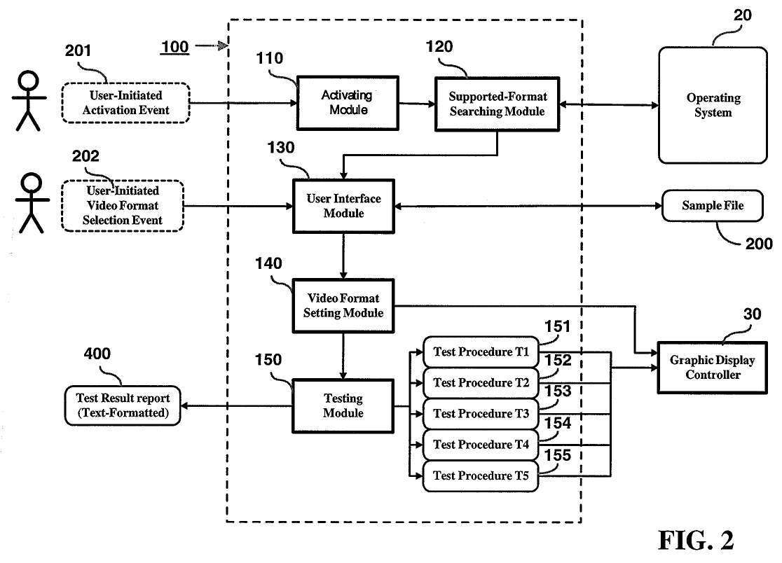

As shown in FIG. 2, in architecture, the computer graphic display controller testing system of the invention 100 is based on an object-oriented component model which comprises: (A) an activating module 110; (B) a supported-format searching module 120; (C) a user interface module 130; (D) a video format setting module 140; and (E) a testing module 150. The respective attributes and functions (i.e., methods) of these constituent components 110, 120, 130, 140, 150 are described in details in the following.

The activating module 110 is designed to allow the user to quickly activate the computer graphic display controller testing system of the invention 100. In practical implementation, for example, the activating module 110 is capable of displaying an icon (not shown) on the desktop of the GUI-based operating system 20 displayed on the monitor screen 11 of the computer platform 10, where the icon allows the user to double-click thereon to initiate an activation event 201 which can cause the activating module 110 to respond by issuing an activation-enable message to the supported-format searching module 120.

The supported-format searching module 120 is designed to respond to the activation-enable message from the activating module 110 by searching through the operating system 20 of the computer platform 10 for all types of video formats that are supported by the operating system 20. For example, assume that the operating system 20 supports two resolutions: 1024*768 and 800*600; two bit depths: 32 bits and 16 bits; and two scan frequencies: 75 Hz and 60 Hz. In this case, there are 2*2*2=8 different combinations from these settings, namely: [1024*768, 32-bit, 75 Hz], [1024*768, 32-bit, 60 Hz], [1024*768, 16-bit, 75 Hz], [1024*768, 16-bit, 60 Hz], [800*600, 32-bit, 75 Hz], [800*600, 32-bit, 60 Hz], [800*600, 16-bit, 75 Hz], and [800*600, 16-bit, 60 Hz].

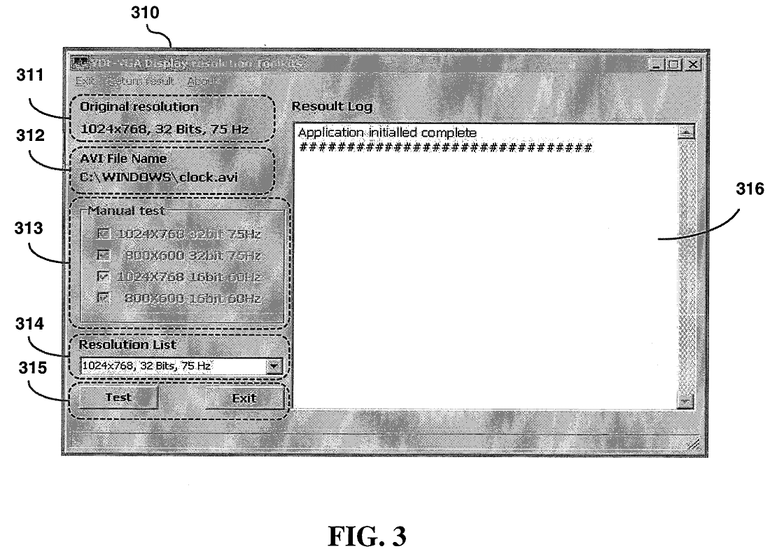

The user interface module 130 is designed for displaying a user interface 310, such as a dialog box shown in FIG. 3, on the monitor screen 11 of the computer platform 10. In implementation, for example, the user interface 310 can be realized in such a manner as to include a previous-format displaying area 311, a sample file source displaying area 312, a manual test format displaying area 313, a supported-format displaying area 314, a set of control buttons 315, and a test result displaying area 316. The previous-format displaying area 311 is used to display a video format that is used in the previous test procedure. The sample file source displaying area 312 is used to display the filename and source (i.e., folder) of a sample file, typically a video file, that is to be used in the testing of the graphic display controller 30. The manual test format displaying area 313 is used to display a set of video formats that are to be used in manually-controlled testing of the graphic display controller 30, which include, for example, [1024*768, 32-bit, 75 Hz], [800*600, 32-bit, 75 Hz], [1024*768, 16-bit, 60 Hz], and [800*600, 16-bit, 60 Hz]. The supported-format displaying area 314 is used to display a combo box for displaying a listing of all the types of video formats found by the supported-format searching module 120 that are supported by the operating system 20 of the computer platform 10, and where the combo box allows the user to select a video format therefrom. The control button set 315 includes a [Test] button and an [Exit] button, where the [Test] button allows the user to activate a test procedure, while the [Exit] button to exit the test procedure. The test result displaying area 316 is used to display the result of each test procedure on the graphic display controller 30. In actual operation, the user can either utilize the listing of supported video formats displayed in the supported-format displaying area 314, or the video formats displayed within the manual test format displaying area 313, to select a video format setting for the graphic display controller 30. Whenever the user selects a video format setting from the supported-format displaying area 314, it represents a user-initiated video format selection event 202, which will cause the user interface module 130 to respond by issuing a video format setting enable message to the video format setting module 140.

The video format setting module 140 is capable of responding to the video format setting enable message from the user interface module 130 by setting the graphic display controller 30 to operate under the user-selected video format from either the supported-format displaying area 314 or the manual test format displaying area 313 of the user interface module 130.

The testing module 150 is capable of responding to a user-clicking of the [Test] button in the control button set 315 shown in the user interface 310 by performing a series of test procedures on the graphic display controller 30 under the video format set by the video format setting module 140. In practical implementation, for example, these test procedures may include: (T1) a multimedia file play test procedure 151; (T2) a window resizing test procedure 152; (T3) a window and icon dragging test procedure 153; (T4) a text-based user interface test procedure 154; and (T5) a drawing function test procedure 155. However, it is to be noted that the testing of the graphic display controller 30 is not limited to these five test procedures, and can further include various other test procedures. Broadly speaking, the testing of the graphic display controller 30 includes the testing of all the available functions of the graphic display controller 30.

The multimedia file play test procedure 151 is used to test the graphic display controller 30 by using a sample file (such as a video file of the AVI format) displayed in the sample file source displaying area 312 to check whether the graphic display controller 30 can play the AVI video file normally. This multimedia file play test procedure 151 differs from the prior art particularly in that the required sample file for the testing is predefined in the program code of the user interface module 130 and thus can be downloaded for use automatically without requiring the user to search through the file management system to find and open the required sample file. This feature allows the overall test work to be more efficient than the prior art.

The window resizing test procedure 152 includes, for example, a looped and program-controlled window resizing test, a user-controlled window resizing test (including maximization, normalization, and minimization), and a window full-screen display test. This window resizing test procedure 152 differs from the prior art particularly in the addition of the window full-screen display test, which allows the testing of window resizing to be more comprehensive than the prior art.

The window and icon dragging test procedure 153 is manually performed by the user, in which the mouse (or an equivalent pointing device) is used to manually drag an open window or an icon displayed on the monitor screen 11 of the computer platform 10. The purpose of this test procedure is to see if there are residual traces left behind the dragged windows or icons during the course of the dragging.

The text-based user interface test procedure 154 is used to check whether the graphic display controller 30 can display a traditional text-based user interface, such as the DOS (Disk Operating System) user interface, by displaying it in full-screen size under normal mode. This text-based user interface test procedure 154 utilizes a window under the GUI-based operating system to display the DOS-based user interface, and further utilizes a looped window resizing program to automatically control the resizing of the window and a code-controlled text-input program to input a string of text into the DOS-based user interface to see if the DOS-based user interface and the inputted text can be correctly displayed. This text-based user interface test procedure 154 differs from the prior art particularly in that the prior art utilizes manual text input method, whereas the invention utilize code-controlled text-input program for automatic input of the text. This feature allows the overall test work to be more efficient than the prior art.

The drawing function test procedure 155 is used to check whether the GDI (Graphic Device Interface) drawing functionality of the Windows operating system 20 is normal. The prior art lacks this test procedure; and therefore, the addition of this test procedure can help make the testing of the graphic display controller 30 more comprehensive.

The following is a detailed description of a practical application example of the computer graphic display controller testing system of the invention 100 during actual operation.

When the user (i.e., QC engineer) wants to carry out a testing on the graphic display controller 30, the user needs first to use mouse to double click an icon on the desktop displayed on the monitor screen 11 of the computer platform 10. This action initiates an activation event 201 which causes the activating module 110 to respond by issuing an activation-enable message to the supported-format searching module 120. In response, the supported-format searching module 120 searches through the operating system 20 of the computer platform 10 for all types of video formats that are supported by the operating system 20, and then activates the user interface module 130 to display all the possible combinations of the supported video formats through the supported-format displaying area 314 of the user interface 310.

To initiate a test procedure, the user needs first to select a video format setting, either from the listing displayed in the supported-format displaying area 314 or the manual test format displaying area 313. When a selection is made by the user, it represents a user-initiated video format selection event 202 which causes the user interface module 130 to respond by issuing a video format setting enable message to the video format setting module 140. In response, the video format setting module 140 sets the graphic display controller 30 to operate under the user-selected video format. Next, the user needs just to click on the [Test] button of the control button set 315 in the user interface 310 for initiating a series of test procedures, including, for example, (T1) a multimedia file play test procedure 151; (T2) a window resizing test procedure 152; (T3) a window and icon dragging test procedure 153; (T4) a text-based user interface test procedure 154; and (T5) a drawing function test procedure 155. When these test procedures are completed, the testing module 150 is activated to generate a text-formatted test result report 400 for review by the QC engineers.

Compared to the prior art, the computer graphic display controller testing system of the invention 100 is more advantageous to use in that it allows the user to initiate the test procedures by clicking the mouse for just 3 to 4 times (i.e., double click the icon to start, click once to select a video format setting from the supported-format displaying area 314 or manual test format displaying area 313, and click once to start the test procedures). This feature allows the user to more quickly and conveniently start the test procedures, and therefore is less laborious and time-consuming and more efficient to implement the testing of the graphic display controller 30. Overall, by using the prior art, it needs about 5 to 6 hours for a 100% completion of the testing on the graphic display controller 30; and by contrast, the invention needs just 2 to 3 hours or shorter. Although the invention incorporates additional GDI and window full-screen test procedures, the overall required time of the testing is nonetheless less than the prior art. As a summary, the efficiency is increased by about 70-75%, while the performance is increased by about 60%.

In conclusion, the invention provides a computer display controller testing method and system for testing a graphic display controller installed on a computer platform, which is characterized in that all video formats that need to be set for testing the graphic display controller can be automatically retrieved and displayed on the user's operating interface, thereby enabling the user to conveniently and quickly be informed of all video formats that are supported by the computer of an indicated graphic display controller under test, and also the efficiency of testing can be improved by reducing the number of times that the user has to click the mouse buttons. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer graphic display controller testing method for testing a graphic display controller installed on a computer platform, which comprises:
responding to a user-initiated activation event by issuing an activation-enable message;
responding to the activation-enable message by searching through the computer platform for all types of video formats that are supported by the computer platform;
displaying a listing of all the possible combinations of video format settings from the supported video format types on the computer platform for user selection;
setting the graphic display controller to operate under the user-selected video format setting; and
performing a series of test procedures on the graphic display controller under the user-selected video format setting.

2. The computer graphic display controller testing system of claim 1, wherein the test procedures include a multimedia file play test procedure.

3. The computer graphic display controller testing system of claim 2, wherein the multimedia file play test procedure utilizes a pre-linked sample file that is prestored in the computer platform.

4. The computer graphic display controller testing system of claim 1, wherein the test procedures include a window resizing test procedure.

5. The computer graphic display controller testing system of claim 1, wherein the test procedures include a window and icon dragging test procedure.

6. The computer graphic display controller testing system of claim 1, wherein the test procedures include a text-based user interface test procedure.

7. The computer graphic display controller testing system of claim 1, wherein the test procedures include a GDI (Graphic Device Interface) drawing function test procedure.

8. A computer graphic display controller testing system for testing a graphic display controller installed on a computer platform, which comprises:
an activating module, which is capable of responding to a user-initiated activation event by issuing an activation-enable message;
a supported-format searching module, which is capable of responding to the activation-enable message from the activating module by searching through the computer platform for all types of video formats that are supported by the computer platform;
a user interface module, which is capable of displaying a listing of all the possible combinations of video format settings from the supported video format types found by the supported-format searching module on the computer platform; and
which is capable of allowing a user-operated selection of one of the video format settings from the listing;
a video format setting module, which is capable of setting the graphic display controller to operate under the user-selected video format setting from the user interface module; and
a testing module, which is capable of performing a series of test procedures on the graphic display controller under the user-selected video format setting.

9. The computer graphic display controller testing system of claim 8, wherein the test procedures performed by the testing module include a multimedia file play test procedure.

10. The computer graphic display controller testing system of claim 9, wherein the multimedia file play test procedure utilizes a sample file predefined in the user interface module for the testing.

11. The computer graphic display controller testing system of claim 8, wherein the test procedures performed by the testing module include a window resizing test procedure.

12. The computer graphic display controller testing system of claim 8, wherein the test procedures performed by the testing module include a window and icon dragging test procedure.

13. The computer graphic display controller testing system of claim 8, wherein the test procedures performed by the testing module include a text-based user interface test procedure.

14. The computer graphic display controller testing system of claim 8, wherein the test procedures performed by the testing module include a GDI (Graphic Device Interface) drawing function test procedure.
